(19) United States
(12) Patent Application Publication
(10) Pub. No.: US 2022/0155800 A1
(43) Pub. Date: May 19, 2022

(54) METHOD AND APPARATUS FOR YAW FUSION AND AIRCRAFT

(71) Applicant: AUTEL ROBOTICS CO., LTD., Shenzhen (CN)

(72) Inventors: Tianbao ZHANG, Shenzhen (CN); Yingjie LI, Shenzhen (CN)

(21) Appl. No.: 17/649,831

(22) Filed: Feb. 3, 2022

Related U.S. Application Data
(63) Continuation of application No. PCT/CN2020/106862, filed on Aug. 4, 2020.

(30) Foreign Application Priority Data
Aug. 9, 2019 (CN) 201910734158.4

(51) Int. Cl. G05D 1/08; B64D 27/02; G01C 21/16; G01C 21/20

(52) U.S. Cl. CPC G05D 1/0816; B64D 27/02; B64C 39/024; G01C 21/20; G01C 21/165

(57) ABSTRACT

Embodiments of the present invention relates to a method and apparatus for yaw fusion and an aircraft. The method includes: acquiring magnetometer data, inertial measurement unit (IMU) data, and global positioning system (GPS) data; determining a yaw angular velocity correction amount according to the GPS data and the magnetometer data; determining a first yaw angular velocity error value according to the IMU acceleration information and the GPS acceleration information; determining an initial complementary fusion yaw angular velocity; determining a second yaw angular velocity error value; and determining a final complementary fusion yaw.

### CROSS-REFERENCE TO RELATED APPLICATIONS

The present application is a continuation of International Application No. PCT/CN2020/106862, filed on Aug. 4, 2020, which claims priority to Chinese Patent Application No. 201910734158.4, filed on Aug. 9, 2019, which is incorporated herein by reference in its entirety.

### TECHNICAL FIELD

The present application relates to the technical field of aircrafts, and in particular, to a method and apparatus for yaw fusion and an aircraft.

### BACKGROUND

Aircrafts, such as unmanned aerial vehicles (UAVs), have been used more widely due to their advantages of small size, light weight, flexible maneuverability, fast response, unmanned driving, and low operation requirements. Various actions (or attitudes) of an unmanned aerial vehicle are usually implemented by controlling a plurality of drive motors in the power device of the unmanned aerial vehicle to operate at different rotational speeds. The yaw is an important parameter in the control of the flight attitude of the unmanned aerial vehicle, i.e., the yaw fusion of the unmanned aerial vehicle is particularly important for the attitude control of the unmanned aerial vehicle. If the yaw fusion of the unmanned aerial vehicle has a large error or the fusion precision is low, the unmanned aerial vehicle may fail to fly according to the preset direction or trajectory, or may orbit unexpectedly or even become unstable and crash in severe cases.

At present, the yaw fusion of the aircraft generally adopts a complementary filtering scheme, in which information of a plurality of sensors is acquired, and the data is fused using weighted scheduling and mutual correction methods. However, in the case of long-term flight or the long-time yaw-angle flight of the aircraft, using primary filtering alone has a large error, and cannot ensure the stability fusion precision of the yaw.

### SUMMARY

Embodiments of the present invention provide a method and apparatus for yaw fusion and an aircraft, to solve the technical problem of a large error in primary complementary filtering and improve the fusion precision and stability of the yaw.

To solve the above technical problem, the embodiments of the present invention provide the following technical solutions.

According to a first aspect, an embodiment of the present invention provides a method for yaw fusion, applicable to an aircraft, the method including:

acquiring magnetometer data, inertial measurement unit (IMU) data, and global positioning system (GPS) data, where the IMU data includes IMU acceleration information and IMU angular velocity information, and the GPS data includes GPS velocity information and GPS acceleration information;

determining a yaw angular velocity correction amount according to the GPS data and the magnetometer data;

determining a first yaw angular velocity error value according to the IMU acceleration information and the GPS acceleration information;

determining an initial complementary fusion yaw angular velocity according to the IMU angular velocity information, the yaw angular velocity correction amount, and the first yaw angular velocity error value;

determining a second yaw angular velocity error value according to the IMU acceleration information and the GPS velocity information; and

determining a final complementary fusion yaw according to the initial complementary fusion yaw angular velocity and the second yaw angular velocity error value.

In some embodiments, the determining a yaw angular velocity correction amount according to the GPS data and the magnetometer data includes:

acquiring a magnetic field vector of a current location of the aircraft according to the GPS data;

determining a magnetic field vector of the magnetometer according to the magnetometer data;

calculating a magnetic north pole error angle according to the magnetic field vector of the current location of the aircraft and the magnetic field vector of the magnetometer; and

determining the yaw angular velocity correction amount according to the magnetic north pole error angle.

In some embodiments, the determining a first yaw angular velocity error value according to the IMU acceleration information and the GPS acceleration information includes:

performing coordinate transformation on the IMU data to generate IMU acceleration information in an earth coordinate system;

performing signal processing on the GPS data to generate horizontal acceleration information; and

calculating a vector angle according to the IMU acceleration information in the earth coordinate system and the horizontal acceleration information, and using the vector angle as the first yaw angular velocity error value.

In some embodiments, before the performing coordinate transformation on the IMU data to generate IMU acceleration information in an earth coordinate system, the method further includes:

generating a stationary flag according to the IMU data, where the stationary flag is used for reflecting whether the aircraft is in a stationary state;

obtaining bias data of the IMU data according to the IMU data and the stationary flag; and

obtaining a difference between the IMU data and the bias data of the IMU data; and

the performing coordinate transformation on the IMU data to generate IMU acceleration information in an earth coordinate system includes:

performing coordinate transformation on the difference between the IMU data and the bias data of the IMU data to generate the IMU acceleration information in the earth coordinate system.

In some embodiments, the determining an initial complementary fusion yaw angular velocity according to the IMU angular velocity information, the yaw angular velocity correction amount, and the first yaw angular velocity error value includes:

summing the IMU angular velocity information in the earth coordinate system, the yaw angular velocity correction amount, and the first yaw angular velocity error value, and using a result of the summation as the initial complementary fusion yaw angular velocity.

In some embodiments, the determining a second yaw angular velocity error value according to the IMU acceleration information and the GPS velocity information includes:

integrating the IMU acceleration information to generate integral IMU velocity information;

normalizing the integral IMU velocity information to generate normalized IMU velocity information;

normalizing the GPS velocity information to generate normalized GPS velocity information;

generating a velocity difference according to the normalized IMU velocity information and the normalized GPS velocity information; and

differentiating the velocity difference to generate the second yaw angular velocity error value.

In an embodiment of the present invention, the determining a final complementary fusion yaw according to the initial complementary fusion yaw angular velocity and the second yaw angular velocity error value includes:

calculating a difference between the initial complementary fusion yaw angular velocity and a final complementary fusion yaw at a previous moment to determine a first angular velocity difference;

calculating a difference between the second yaw angular velocity error value and the final complementary fusion yaw at the previous moment to determine a second angular velocity difference;

determining a first weight and a second weight according to the first angular velocity difference and the second angular velocity difference;

normalizing the first weight and the second weight to generate a first weight proportion coefficient and a second weight proportion coefficient;

multiplying the initial complementary fusion yaw angular velocity and the first weight proportion coefficient to generate a first product value;

multiplying the second yaw angular velocity error value and the second weight proportion coefficient to generate a second product value; and

determining the final complementary fusion yaw according to the first product value and the second product value.

In some embodiments, the determining the final complementary fusion yaw according to the first product value and the second product value includes:

summing the first weight and the second weight to generate a weight sum;

summing the first product value and the second product value to generate a product sum; and

determining the final complementary fusion yaw according to the weight sum and the product sum.

According to a second aspect, an embodiment of the present invention provides an apparatus for yaw fusion, applicable to an aircraft, the apparatus including:

an acquisition module, configured to acquire magnetometer data, IMU data, and GPS data, where the IMU data includes IMU acceleration information and IMU angular velocity information, and the GPS data includes GPS velocity information and GPS acceleration information;

a yaw angular velocity correction amount module, configured to determine a yaw angular velocity correction amount according to the GPS data and the magnetometer data;

a first yaw angular velocity error value module, configured to determine a first yaw angular velocity error value according to the IMU acceleration information and the GPS acceleration information;

an initial complementary fusion yaw angular velocity module, configured to determine an initial complementary fusion yaw angular velocity according to the IMU angular velocity information, the yaw angular velocity correction amount, and the first yaw angular velocity error value;

a second yaw angular velocity error value module, configured to determine a second yaw angular velocity error value according to the IMU acceleration information and the GPS velocity information; and

a final complementary fusion yaw module, configured to determine a final complementary fusion yaw according to the initial complementary fusion yaw angular velocity and the second yaw angular velocity error value.

In some embodiments, the yaw angular velocity correction amount module is further configured to:

acquire a magnetic field vector of a current location of the aircraft according to the GPS data;

determine a magnetic field vector of the magnetometer according to the magnetometer data;

calculate a magnetic north pole error angle according to the magnetic field vector of the current location of the aircraft and the magnetic field vector of the magnetometer; and

determine the yaw angular velocity correction amount according to the magnetic north pole error angle.

In some embodiments, the first yaw angular velocity error value module is further configured to:

perform coordinate transformation on the IMU data to generate IMU acceleration information in an earth coordinate system;

perform signal processing on the GPS data to generate horizontal acceleration information; and

calculate a vector angle according to the IMU acceleration information in the earth coordinate system and the horizontal acceleration information, and use the vector angle as the first yaw angular velocity error value.

In some embodiments, the apparatus further includes:

a stationary flag module, configured to generate a stationary flag according to the IMU data, where the stationary flag is used for reflecting whether the aircraft is in a stationary state;

an IMU bias data difference module, configured to obtain bias data of the IMU data according to the IMU data and the stationary flag; and obtain a difference between the IMU data and the bias data of the IMU data; and

the first yaw angular velocity error value module is further configured to:

perform coordinate transformation on the difference between the IMU data and the bias data of the IMU data to generate the IMU acceleration information in the earth coordinate system.

In some embodiments, the initial complementary fusion yaw angular velocity module is further configured to:

sum the IMU angular velocity information in the earth coordinate system, the yaw angular velocity correction amount, and the first yaw angular velocity error value, and use a result of the summation as the initial complementary fusion yaw angular velocity.

In some embodiments, the second yaw angular velocity error value module is further configured to:

integrate the IMU acceleration information to generate integral IMU velocity information;

normalize the integral IMU velocity information to generate normalized IMU velocity information;

normalize the GPS velocity information to generate normalized GPS velocity information;

generate a velocity difference according to the normalized IMU velocity information and the normalized GPS velocity information; and

differentiate the velocity difference to generate the second yaw angular velocity error value.

In some embodiments, the final complementary fusion yaw module includes:

a first angular velocity difference unit, configured to calculate a difference between the initial complementary fusion yaw angular velocity and a final complementary fusion yaw at a previous moment to determine a first angular velocity difference;

a second angular velocity difference unit, configured to calculate a difference between the second yaw angular velocity error value and the final complementary fusion yaw at the previous moment to determine a second angular velocity difference;

a weight unit, configured to determine a first weight and a second weight according to the first angular velocity difference and the second angular velocity difference;

a weight proportion coefficient unit, configured to normalize the first weight and the second weight to generate a first weight proportion coefficient and a second weight proportion coefficient;

a first product value unit, configured to multiply the initial complementary fusion yaw angular velocity and the first weight proportion coefficient to generate a first product value;

a second product value unit, configured to multiply the second yaw angular velocity error value and the second weight proportion coefficient to generate a second product value; and

a final complementary fusion yaw unit, configured to determine the final complementary fusion yaw according to the first product value and the second product value.

In some embodiments, the final complementary fusion yaw unit is further configured to:

sum the first weight and the second weight to generate a weight sum;

sum the first product value and the second product value to generate a product sum; and

determine the final complementary fusion yaw according to the weight sum and the product sum.

According to a third aspect, an embodiment of the present invention provides an aircraft, including:

a body;

an arm, connected to the body;

a power device, disposed on the arm and configured to supply power for flight of the aircraft; and

a flight controller, disposed on the body,

where the flight controller includes:

at least one processor; and

a memory communicably connected to the at least one processor, where

the memory stores instructions executable by the at least one processor, where the instructions are executed by the at least one processor to cause the at least one processor to execute the above method for yaw fusion.

According to a fourth aspect, an embodiment of the present invention further provides a non-volatile computer readable storage medium, storing computer-executable instructions therein, where the computer-executable instructions are configured to cause an aircraft to execute the above method for yaw fusion.

Beneficial effects of the embodiments of the present invention are as follows: Different from the prior art, the embodiments of the present invention provide a method for yaw fusion, applicable to an aircraft, the method including: acquiring magnetometer data, IMU data, and GPS data, where the IMU data includes IMU acceleration information and IMU angular velocity information, and the GPS data includes GPS velocity information and GPS acceleration information; determining a yaw angular velocity correction amount according to the GPS data and the magnetometer data; determining a first yaw angular velocity error value according to the IMU acceleration information and the GPS acceleration information; determining an initial complementary fusion yaw angular velocity according to the IMU angular velocity information, the yaw angular velocity correction amount, and the first yaw angular velocity error value; determining a second yaw angular velocity error value according to the IMU acceleration information and the GPS velocity information; and determining a final complementary fusion yaw according to the initial complementary fusion yaw angular velocity and the second yaw angular velocity error value. Whereby, the present invention solves the technical problem of a large error in primary complementary filtering and improve the fusion precision and stability of the yaw.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a detailed structural diagram of an aircraft according to an embodiment of the present invention;

FIG. 2 is a functional block diagram of a method for yaw fusion according to an embodiment of the present invention;

FIG. 3 is a functional block diagram of a secondary complementary filtering algorithm in FIG. 2;

FIG. 4 is a functional block diagram of another secondary complementary filtering algorithm in FIG. 2;

FIG. 5 is a schematic flowchart of a method for yaw fusion according to an embodiment of the present invention;

FIG. 6 is a detailed flowchart of step S20 in FIG. 5;

FIG. 7 is a detailed flowchart of step S30 in FIG. 5;

FIG. 8 is a detailed flowchart of step S50 in FIG. 5;

FIG. 9 is a detailed flowchart of step S60 in FIG. 5;

FIG. 10 is a detailed flowchart of step S67 in FIG. 9;

FIG. 11 is a schematic diagram of an apparatus for yaw fusion according to an embodiment of the present invention;

FIG. 12 is a schematic diagram of a final complementary fusion yaw module in FIG. 11;

FIG. 13 is a schematic diagram of a hardware structure of an aircraft according to an embodiment of the present invention;

FIG. 14 is a connection block diagram of an aircraft according to an embodiment of the present invention; and

FIG. 15 is a schematic diagram of a power device in FIG. 14.

### DETAILED DESCRIPTION

To make the objectives, technical solutions and advantages of the embodiments of the present invention clearer, the technical solutions in the embodiments of the present invention will be described clearly and thoroughly with reference to the accompanying drawings in the embodiments of the present invention. Apparently, the embodiments described are merely some embodiments, rather than all of the embodiments of the present invention. All other embodiments obtained by a person of ordinary skill in the art without creative efforts based on the embodiments of the present invention shall fall within the protection scope of the present invention.

In addition, the technical features involved in various embodiments of the present invention described below can be combined with each other as long as they do not form a conflict with each other.

The method for yaw fusion provided by the embodiments of the present invention may be applied to various movable objects driven by a motor, including, but not limited to, an aircraft, a robot, and the like. The aircraft may include a UAV, an unmanned spacecraft, and the like.

The method for yaw fusion according to the embodiments of the present invention is applied to a flight controller of an aircraft.

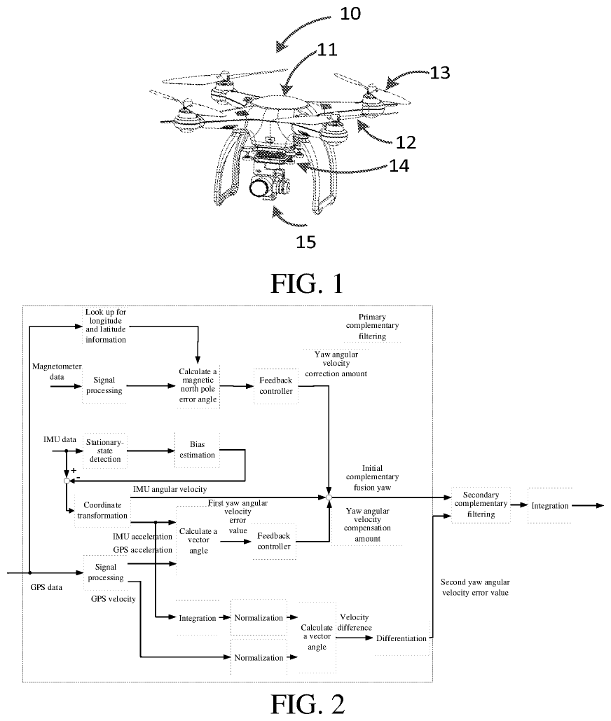

FIG. 1 is a detailed structural diagram of an aircraft according to an embodiment of the present invention.

As shown in FIG. 1, the aircraft 10 includes: a body 11, an arm 12 connected to the body 11, a power device 13 disposed on the body 12, a gimbal 14 connected to a bottom of the body 11, a camera 15 installed on the gimbal 14, and a flight controller (not shown) disposed in the body 11.

The flight controller is connected to the power device 13, and the power device 13 is installed on the body 11 and is configured to provide power for flight of the aircraft 10. Specifically, the flight controller is configured to execute the above method for yaw fusion to correct a yaw of the aircraft, generate a control instruction according to the fused yaw of the aircraft, and send the control instruction to an electronic speed controller of the power device 13, and the electronic speed controller controls a drive motor of the power device 13 according to the control instruction. Alternatively, the flight controller is configured to execute the method for yaw fusion to correct the yaw of the aircraft, and send the corrected yaw of the aircraft to the electronic speed controller, and the electronic speed controller generates a control instruction according to the corrected yaw of the aircraft, and controls the drive motor of the power device 13 according to the control instruction.

The body 11 includes: a central housing and one or more arms connected to the central housing. The one or more arms extend radially from the central housing. The connection between the arm and the central housing may means that the arm and the central housing are integrally formed or are fixed together. The power device is installed on the arm.

The flight controller is configured to execute the above method for yaw fusion to correct a yaw of the aircraft, generate a control instruction according to the corrected yaw of the aircraft, and send the control instruction to an electronic speed controller of the power device, so that the electronic speed controller controls a drive motor of the power device according to the control instruction. The flight controller is a device with a certain logic processing capability, such as a control chip, a single chip microcomputer, a microcontroller unit (MCU), and the like.

The power device 13 includes: the electronic speed controller, the drive motor and a propeller. The electronic speed controller is located in a cavity formed by the arm or the central housing. The electronic speed controller is connected to the flight controller and the drive motor. Specifically, the electronic speed controller is electrically connected to the drive motor and is configured to control the drive motor. The drive motor is installed on the arm, and a rotating shaft of the drive motor is connected to the propeller. The propeller is configured to be driven by the drive motor to generate a force that causes the aircraft 10 to move, e.g., a lift or thrust force that causes the aircraft 10 to move.

The set speeds and action (or attitudes) of the aircraft 10 are implemented by using the electronic speed controller to control the drive motor. The electronic speed controller is configured to adjust a rotational speed of the drive motor of the aircraft 10 according to a control signal. The flight controller is an entity for executing the above method for yaw fusion, and the electronic speed controller controls the drive motor based on the control instruction generated according to the fused yaw of the aircraft. The principle of controlling the drive motor by the electronic speed controller is roughly as follows: The drive motor is an open-loop control element that converts an electrical pulse signal into an angular displacement or a linear displacement. In the case of non-overload, the rotational speed and stop position of the drive motor only depend on the frequency and number of pulses of the pulse signal, and are not affected by the change in load. When receiving a pulse signal, a electronic speed controller drives the drive motor of the power device to rotate by a fixed angle in a set direction. Therefore, the electronic speed controller can control the angular displacement by controlling the number of pulses, so as to achieve accurate positioning; and can also control the rotational speed and acceleration of the drive motor by controlling the pulse frequency, so as to achieve speed adjustment.

At present, main functions of the aircraft 10 include aerial photography, real-time image transmission, detection of high-risk areas, and the like. In order to implement the functions such as aerial photography, real-time image transmission, and detection of high-risk areas, a photography assembly is connected to the aircraft 10. Specifically, the aircraft 10 and the photography assembly are connected by a connection structure such as a vibration-damping ball. The photography assembly is configured to capture an image during an aerial photographing process of the aircraft 10.

Specifically, the photography assembly includes: a gimbal and a photographing device. The gimbal is connected to the aircraft 10. The photographing device is mounted on the gimbal. The photographing device may be an image capturing device for capturing an image. The photographing device includes but is not limited to: a camera, a video recorder, a scanner, a camera phone, etc. The gimbal is configured for mounting the photographing device, so as to fix of the photographing device, or adjust the pose of the photographing device at will (for example, change the height, inclination and/or direction of the photographing device) and stably maintain the photographing device in a set pose. For example, when the aircraft 10 performs aerial photography, the gimbal is mainly used for stably maintaining the photographing device in a set posture, to prevent the photographing device from shaking during photographing, thereby ensuring the stability of photographing.

The gimbal 14 is connected to the flight controller to implement data interaction between the gimbal 14 and the flight controller. For example, the flight controller sends a yaw instruction to the gimbal 14, the gimbal 14 acquires a yaw speed and yaw direction and executes the yaw instruction, and sends data information generated after executing the yaw instruction to the flight controller, so that the flight controller detects a current yaw status.

The gimbal includes: a gimbal motor and a gimbal base. The gimbal motor is installed on the gimbal base. The flight controller may also control the gimbal motor by using the electronic speed controller of the power device 13. Specifically, the flight controller is connected to the electronic speed controller. The electronic speed controller is electrically connected to the gimbal motor. The flight controller generates a gimbal motor control instruction, and the electronic speed controller controls the gimbal motor according to the gimbal motor control instruction.

The gimbal base is connected to the body of the aircraft, and is configured to fix the photography assembly to the body of the aircraft.

The gimbal motor is connected to the gimbal base and the photographing device. The gimbal may be a multi-axis gimbal, and correspondingly, there are a plurality of gimbal motors, i.e., each axis is provided with one gimbal motor. On the one hand, the gimbal motor may the photographing device to rotate, so as to implement the horizontal rotation and the adjustment of a pitch angle of the photographing device, and the rotation of the gimbal motor may be manually controlled remotely or may be automatically controlled by a program, so as to implement all-round scanning and monitoring. On the other hand, in the aerial photographing process of the aircraft, the disturbance of the photographing device is offset in real time by the rotation of the gimbal motor, to prevent the photographing device from shaking during photographing, thereby ensuring the stability of photographing.

The photographing device is mounted on the gimbal. An inertial measurement unit (IMU) is disposed on the photographing device. The inertial measurement unit is configured to measure a three-axis attitude angle (or angular velocity) and acceleration of an object. Generally, the IMU is equipped with a three-axis gyroscope and a three-direction accelerometer to measure an angular velocity and acceleration of an object in a three-dimensional space and calculate an attitude of the object. To increase reliability, more sensors may be equipped for each axis. Generally speaking, the IMU needs to be installed at the center of gravity of the aircraft.

In the process of controlling the attitude of the aircraft, the yaw of the aircraft is an important parameter in controlling the attitude of the aircraft, and the drive motor needs to be controlled based on the yaw of the aircraft. The yaw of the aircraft is obtained in real time by using the flight controller of the aircraft to provide necessary attitude information for the attitude control of the aircraft. That is to say, the correct estimation of the yaw of the aircraft is particularly important for the attitude control of the aircraft. If the yaw of the aircraft is estimated incorrectly, the aircraft may not be able to fly along a preset direction or trajectory, or may even become unstable and crash.

In an indoor environment, because there is no GPS information correction and the magnetometer is also severely interfered, there is a lack of sufficient available information to correct the yaw. Moreover, due to the drift characteristic of gyroscope integration, the aircraft is prone to yaw deviation when flying or hovering indoor.

At present, the indoor flight of the aircraft mainly relies on visual information correction or magnetometer correction to correct the yaw. However, visual information correction is not applicable to aircrafts without vision, and requires a large amount of visual computing, which affects the calculation of other visual information for aircrafts where the vision unit has a weak computing power. In order to avoid the impact on the calculation of other visual information, the vision unit needs to be replaced with a better vision module, which increases the costs. The method of using the magnetometer correction is prone to a serious deviation or drift of the yaw of the aircraft during interference.

Therefore, in view of the above problems, a main objective of the embodiments of the present invention is to provide a method and apparatus for yaw fusion and an aircraft, which can correct the yaw of the aircraft through secondary complementary fusion, so as to solve the problem of a large error caused by using primary filtering alone in the case of long-term flight or the long-time yaw flight of the aircraft, thereby improving the fusion precision and stability of the yaw.

In the embodiments of the present invention, GPS data, IMU data, and magnetometer data are acquired, the yaw is corrected by using data of a plurality of sensors as much as possible, and after primary complementary filtering, secondary complementary filtering is performed for compensation, which can ensure the stability of filtering.

The embodiments of the present invention will be further described in detail below with reference to the accompanying drawings.

### Embodiment 1

FIG. 2 is a functional block diagram of a method for yaw fusion according to an embodiment of the present invention.

As shown in FIG. 2, GPS data, magnetometer data, and IMU data are acquired; according to the GPS data, latitude and longitude information is looked up in a table; signal processing is performed on the magnetometer data to obtain a magnetic north pole error angle; the magnetic north pole error angle is inputted into a feedback controller, so that the feedback controller generates a yaw angular velocity correction amount by means of feedback; an IMU angular velocity is obtained according to the IMU data; a yaw angular velocity compensation amount is obtained according to the GPS data and the IMU data; the yaw angular velocity correction amount, the IMU angular velocity, and the yaw angular velocity compensation amount are fused to generate an initial complementary fusion yaw; an IMU acceleration is integrated, and a velocity obtained by the integration is normalized; signal processing is performed on the GPS data to obtain a GPS velocity, the GPS velocity is normalized, a vector angle is calculated for the normalized velocity, and the vector angle is differentiated to generate a second yaw angular velocity error value; secondary complementary filtering is performed on the initial complementary fusion yaw and the second yaw angular velocity error value to obtain a final yaw angular velocity; and the final yaw angular velocity is integrated to obtain a final complementary fusion yaw.

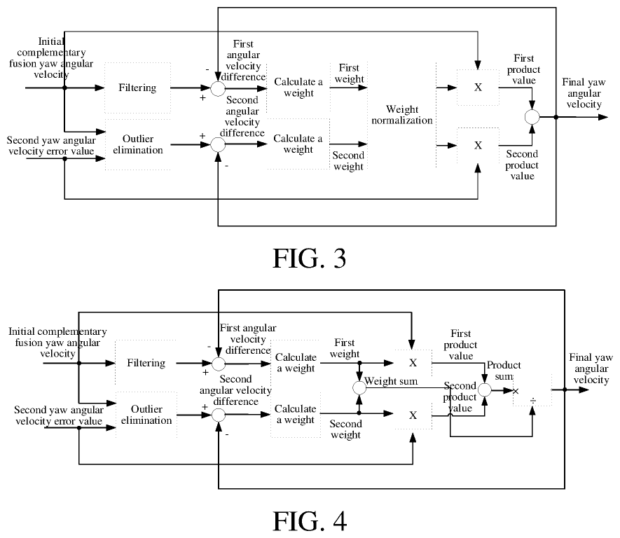

FIG. 3 is a functional block diagram of a secondary complementary filtering algorithm in FIG. 2.

As shown in FIG. 3, filtering and outlier elimination processing are performed on the initial complementary fusion yaw angular velocity; outlier elimination processing is performed on the second yaw angular velocity error value; a vector angle is calculated according to the processed initial complementary fusion yaw angular velocity and the final yaw angular velocity to obtain a first angular velocity difference; a vector angle is calculated according to the second yaw angular velocity error value and the final yaw angular velocity to obtain a second angular velocity difference; a first weight and a second weight are generated respectively according to the first angular velocity difference and the second angular velocity difference; weight normalization processing is performed on the first weight and the second weight; the normalized first weight and the normalized second weight are respectively multiplied with the corresponding initial complementary fusion yaw angular velocity or second yaw angular velocity error value to obtain a first product value and a second product value; and the first product value and the second product value are fused to generate the final yaw angular velocity.

FIG. 4 is a functional block diagram of a secondary complementary filtering algorithm in FIG. 2.

The secondary complementary filtering algorithm in FIG. 4 is similar to the secondary complementary filtering algorithm in FIG. 3 for the most part, which will not be repeated herein. The difference lies in that the secondary complementary filtering algorithm in FIG. 4 sums the first weight and the second weight to generate a weight sum, divides the product sum by the weight sum, and uses the result of the division as the final yaw angular velocity.

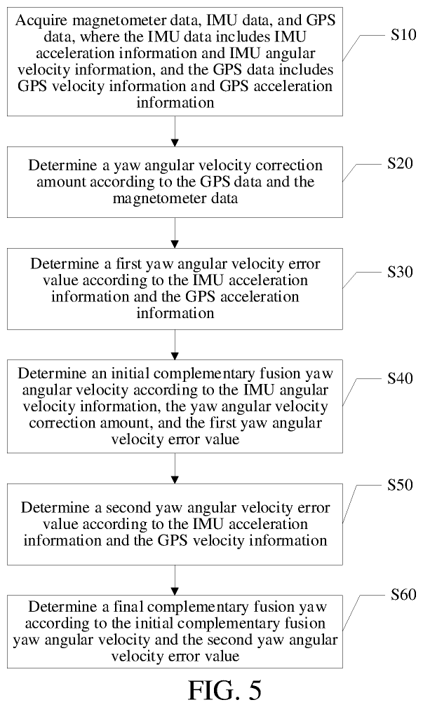

FIG. 5 is a schematic flowchart of a method for yaw fusion according to an embodiment of the present invention.

The method for yaw fusion may be executed by various electronic devices with a certain logic processing capability, such as an aircraft, a control chip, etc. The aircraft may include a UAV, an unmanned spacecraft, and the like. Descriptions are given below by using an aircraft as an example of the electronic device. The aircraft is connected to a gimbal, and the gimbal includes a gimbal motor and a gimbal base. The gimbal may be a multi-axis gimbal, such as a two-axis gimbal or a three-axis gimbal. The three-axis gimbal is used as an example for description below. For specific structures of the aircraft and the gimbal, reference may be made to the above descriptions, and the details will not be repeated herein.

As shown in FIG. 5, the method is applied to an aircraft, such as a UAV, and includes the following steps:

Step S10: Acquire magnetometer data, IMU data, and GPS data, where the IMU data includes IMU acceleration information and IMU angular velocity information, and the GPS data includes GPS velocity information and GPS acceleration information;

Specifically, the aircraft is equipped with an attitude sensor assembly, and the attitude sensor assembly includes: an IMU, a magnetometer, etc. The IMU is configured to acquire the IMU data. The magnetometer is configured to acquire the magnetometer data. The IMU includes a gyroscope and an accelerometer. The gyroscope is configured to acquire an IMU angular velocity. The accelerometer is configured to acquire IMU angular velocity information. The IMU data includes: IMU acceleration information and IMU angular velocity information. The magnetometer data includes: magnetic field strength information. The aircraft is further equipped with a GPS module. The GPS module is configured to acquire the GPS data. The GPS data includes GPS velocity information and GPS acceleration information.

Specifically, the IMU acquires IMU data, where the IMU data acquired by the IMU is original IMU data, and the original IMU data needs to be processed. For example, calibration and coordinate system conversion are performed on the IMU data to generate IMU acceleration information and IMU angular velocity information. The IMU acceleration information is acceleration information in an earth coordinate system obtained by calibrating measurement data of the IMU by using a calibration matrix and transforming coordinates from a body coordinate system to the earth coordinate system. It can be understood that the calibration matrix is obtained by a user at a place where the flight starts, and the calibration matrix varies at different places on the Earth, and when the aircraft experience magnetometer interference, the user needs to perform calibration in order to determine the calibration matrix.

The transformation from the body coordinate system to the earth coordinate system is implemented by using a rotation transformation matrix. Specifically, a rotation transformation matrix is generated according to an attitude angle of the aircraft, and the IMU data is transformed from the body coordinate system to the earth coordinate system by using the rotation transformation matrix, to generate the IMU acceleration information and the IMU angular velocity information. Specifically, the attitude angle of the aircraft includes: a yaw, a pitch angle, and a roll angle. The yaw is a current fused yaw, i.e., the real-time fused yaw will be used for calculating the rotation transformation matrix, and then used for a next fusion, so as to continuously update the fused yaw. For example, the rotation transformation matrix is a 3*3 matrix, where sine and cosine functions of the yaw, the pitch angle, and the roll angle are included, and different functions are selected according to specific situations. Generally speaking, the yaw is rotated first, then the pitch angle is rotated, and finally the roll angle is rotated. For example, the rotation transformation matrix is:

$$D = [ \begin{matrix}cos ψ & - cos ϕ sin ψ & 0 \\ sin ψ & cos ϕ cos ψ & 0 \\ 0 & sin ϕ & 1\end{matrix} ]$$

where, (ϕ, θ, ψ) is the attitude angle, ϕ is the roll angle in the attitude angle, θ is the pitch angle in the attitude angle, and ψ is the yaw in the attitude angle.

Step S20: Determine a yaw angular velocity correction amount according to the GPS data and the magnetometer data.

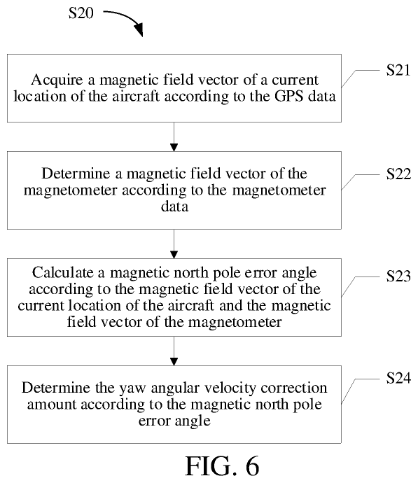

The magnetometer data is acquired by the magnetometer. The magnetometer data includes magnetic field strength information. The magnetic field strength is a three-axis magnetic field strength. Because the magnetometer data measured by the magnetometer is the three-axis magnetic field strength in the body coordinate system, it is necessary to perform bias removal and cross-coupling by using the calibration matrix, and the magnetometer data needs to be transformed to the earth coordinate system by using a rotation matrix. Specifically, FIG. 6 is a detailed flowchart of step S20 in FIG. 5.

As shown in FIG. 6, the determining a yaw angular velocity correction amount according to the GPS data and the magnetometer data includes the following steps:

Step S21: Acquire a magnetic field vector of a current location of the aircraft according to the GPS data.

Specifically, after the aircraft is powered on outdoors, the GPS module of the aircraft receives GPS data, where the GPS data includes latitude and longitude information and velocity information. Interpolation calculation is performed on the latitude and longitude information to determine a standard magnetic field strength, a magnetic declination angle, and a magnetic inclination angle of the aircraft, i.e., acquire a magnetic field vector at the current location of the aircraft.

Step S22: Determine a magnetic field vector of the magnetometer according to the magnetometer data.

Specifically, the aircraft is equipped with a magnetometer, the magnetometer may be a three-axis magnetometer, and readings of the three axes of the magnetometer form a vector, thereby determining the magnetic field vector of the magnetometer.

It can be understood that, the magnetometer data needs to be calibrated due to interference. Specifically, the magnetometer data is calibrated according to a preset calibration matrix to generate calibrated magnetometer data. The preset calibration matrix is obtained by a user at a place where the flight starts, and the calibration matrix varies at different places on the Earth, and when the aircraft reports magnetometer interference, the user needs to perform calibration in order to determine the calibration matrix.

Step S23: Calculate a magnetic north pole error angle according to the magnetic field vector of the current location of the aircraft and the magnetic field vector of the magnetometer.

A local standard magnetic field strength, magnetic declination angle, and magnetic inclination angle are used in combination with the magnetometer data to calculate a heading direction. The calculated heading direction is compared with an actual heading direction of the aircraft. By transformation using a rotation matrix, a magnetic north pole error of the magnetometer of the aircraft may be obtained according to current fused attitude information of the aircraft. Specifically, a transposed matrix of an existing attitude angle rotation matrix is multiplied by the magnetic field vector of the magnetometer to obtain a transformed magnetic field vector, a standard Earth magnetic field vector at the current location of the aircraft is obtained, a vector angle between the standard Earth magnetic field vector at the current location of the aircraft and the transformed magnetic field vector is calculated, and the calculated vector angle is used as the magnetic north pole error angle.

Step S24: Determine the yaw angular velocity correction amount according to the magnetic north pole error angle.

Specifically, the aircraft is equipped with a feedback controller. The magnetic north pole error angle is inputted to the feedback controller, and the feedback controller performs calculation according to the magnetic north pole error angle by using a feedback control algorithm to generate the yaw angular velocity correction amount. For example, the yaw angular velocity correction amount is negatively correlated with the magnetic north pole error angle. For example, the yaw angular velocity correction amount is calculated by using the following formula, Correct=−K*error, where Correct represents the yaw angular velocity correction amount, K represents a gain, and the value of K needs to be set by an engineer according to situations.

Step S30: Determine a first yaw angular velocity error value according to the IMU acceleration information and the GPS acceleration information.

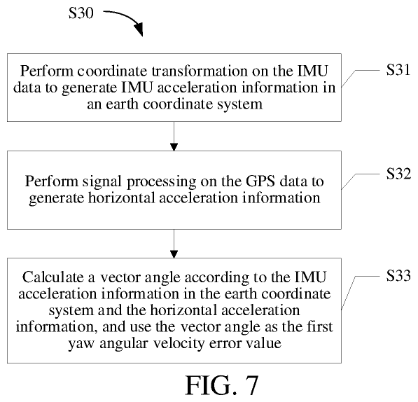

The IMU acceleration is acceleration information obtained by performing corresponding processing on the original IMU data measured by the IMU, for example, by performing coordinate system transformation, bias estimation, etc. on the original IMU data. Specifically, FIG. 7 is a detailed flowchart of step S30 in FIG. 5.

As shown in FIG. 7, the determining a first yaw angular velocity error value according to the IMU acceleration information and the GPS acceleration information includes the following steps:

Step S31: Perform coordinate transformation on the IMU data to generate IMU acceleration information in an earth coordinate system.

Specifically, the IMU data is original IMU data measured by the IMU, and needs to be transformed from the body coordinate system to the earth coordinate system through coordinate system transformation. The transformation from the body coordinate system to the earth coordinate system is implemented using a rotation transformation matrix. Specifically, A rotation transformation matrix is generated according to an attitude angle of the aircraft, and the IMU data is transformed from the body coordinate system to the earth coordinate system by using the rotation transformation matrix, to generate the IMU acceleration information and the IMU angular velocity information. Specifically, the attitude angle of the aircraft includes: a yaw, a pitch angle, and a roll angle. The yaw is a current fused yaw, i.e., the real-time fused yaw will be used for calculating the rotation transformation matrix, and then used for a next fusion, so as to continuously update the fused yaw. For example, the rotation transformation matrix is a 3*3 matrix, where sine and cosine functions of the yaw, the pitch angle, and the roll angle are included, and different functions are selected according to specific situations. Generally speaking, the yaw is rotated first, then the pitch angle is rotated, and finally the roll angle is rotated. For example, the rotation transformation matrix is:

$$D = [ \begin{matrix}cos ψ & - cos ϕ sin ψ & 0 \\ sin ψ & cos ϕcos ψ & 0 \\ 0 & sin ϕ & 1\end{matrix} ]$$

where, (ϕ, θ, ψ) is the attitude angle, ϕ is the roll angle in the attitude angle, θ is the pitch angle in the attitude angle, and ψ is the yaw in the attitude angle.

In an embodiment of the present invention, before the performing coordinate transformation on the IMU data to generate IMU acceleration information in an earth coordinate system, the method further includes:

generating a stationary flag according to the IMU data, where the stationary flag is used for reflecting whether the aircraft is in a stationary state;

obtaining bias data of the IMU data according to the IMU data and the stationary flag; and

obtaining a difference between the IMU data and the bias data of the IMU data; and

the performing coordinate transformation on the IMU data to generate IMU acceleration information in an earth coordinate system includes:

performing coordinate transformation on the difference between the IMU data and the bias data of the IMU data to generate the IMU acceleration information in the earth coordinate system.

Specifically, before the coordinate system transformation is performed on the IMU data, bias estimation is performed for the original IMU data. Because the IMU data has a bias characteristic, the bias of the IMU data needs to be taken into consideration. According to the acceleration and angular velocity information acquired by the IMU, it is determined whether the aircraft is in a stationary state, and a stationary flag is generated. Then the IMU data and the stationary flag are packaged, for which bias estimation is performed to obtain bias data of the IMU data, i.e., obtain acceleration bias information and angular velocity bias information. The acceleration bias information and the angular velocity bias information are both corresponding bias values. A difference between the IMU data and the bias data of the IMU data is obtained, i.e., a difference between the acceleration information in the IMU data and the acceleration bias information is calculated, to generate estimated acceleration information. Similarly, a difference between the angular velocity information in the IMU data and the angular velocity bias information is calculated, to generate estimated angular velocity information. The use of bias estimation to remove the impact of the bias facilitates the correction of the yaw.

The performing coordinate transformation on the difference between the IMU data and the bias data of the IMU data to generate the IMU acceleration information in the earth coordinate system includes: performing coordinate system transformation on the estimated acceleration information and the estimated angular velocity information, to generate acceleration information and angular velocity information in the earth coordinate system. It can be understood that the acceleration information and the angular velocity information in the earth coordinate system are still not accurate enough, and needs to be further corrected.

Step S32: Perform signal processing on the GPS data to generate horizontal acceleration information.

Specifically, the GPS data is used for calculating a GPS acceleration and a GPS velocity. Because the GPS acceleration calculated from the GPS data has noise, signal processing is required. For example, filtering is required. There are a variety of filtering algorithms, such as Kalman filtering, mean filtering, frequency domain low-pass filtering, and so on. By filtering the GPS data, data noise is eliminated, so that the accuracy can be improved. By performing signal processing on the GPS data, horizontal acceleration information and horizontal velocity information are generated.

Step S33: Calculate a vector angle according to the IMU acceleration information in the earth coordinate system and the horizontal acceleration information, and use the vector angle as the first yaw angular velocity error value.

Specifically, because the IMU acceleration information and the horizontal acceleration information are from different sensors, the IMU acceleration information and the horizontal acceleration information can be used for yaw correction. A vector angle is calculated according to the IMU acceleration information in the earth coordinate system and the horizontal acceleration information, to obtain an angle difference between the IMU acceleration information and the horizontal acceleration information in the earth coordinate system, and the vector angle is used as the first yaw angular velocity error value.

Step S40: Determine an initial complementary fusion yaw angular velocity according to the IMU angular velocity information, the yaw angular velocity correction amount, and the first yaw angular velocity error value.

Specifically, the determining an initial complementary fusion yaw angular velocity according to the IMU angular velocity information, the yaw angular velocity correction amount, and the first yaw angular velocity error value includes:

summing the IMU angular velocity information in the earth coordinate system, the yaw angular velocity correction amount, and the first yaw angular velocity error value, and using a result of the summation as the initial complementary fusion yaw angular velocity. The initial complementary fusion yaw is yaw angular velocity information obtained after primary complementary correction.

Specifically, the method further includes: inputting the first yaw angular velocity error value into the feedback controller, so that the feedback controller performs calculation according to the first yaw angular velocity error value by using a feedback control algorithm to generate a yaw angular velocity compensation amount. For example, the yaw angular velocity compensation amount is negatively correlated with the first yaw angular velocity error value. For example, the yaw angular velocity compensation amount is calculated by using the following formula, Correct=−K*error, where Correct represents the yaw angular velocity compensation amount, K represents a gain, and the value of K needs to be set by an engineer according to situations.

The IMU angular velocity information, the yaw angular velocity correction amount, and the first yaw angular velocity compensation amount are fused to generate an initial complementary fusion yaw. The initial complementary fusion yaw is yaw angular velocity information obtained after primary complementary correction.

Step S50: Determine a second yaw angular velocity error value according to the IMU acceleration information and the GPS velocity information.

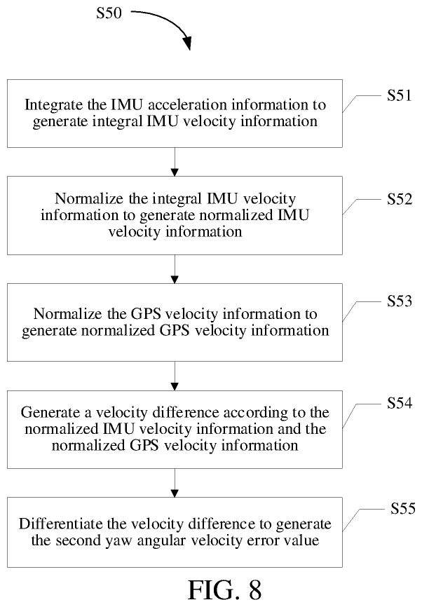

Specifically, FIG. 8 is a detailed flowchart of step S50 in FIG. 5.

As shown in FIG. 8, the determining a second yaw angular velocity error value according to the IMU acceleration information and the GPS velocity information includes the following steps:

Step S51: Integrate the IMU acceleration information to generate integral IMU velocity information.

Specifically, the IMU acceleration information in the earth coordinate system is integrated to generate the integral IMU velocity information.

Step S52: Normalize the integral IMU velocity information to generate normalized IMU velocity information.

Because the integral IMU velocity information obtained by the integration operation may have a drift, it is necessary to normalize the integral IMU velocity information to generate normalized IMU velocity information.

Step S53: Normalize the GPS velocity information to generate normalized GPS velocity information.

Because the GPS velocity information may have a drift, it is necessary to normalize the GPS velocity information to generate normalized GPS velocity information.

Step S54: Generate a velocity difference according to the normalized IMU velocity information and the normalized GPS velocity information.

Specifically, vectorization processing is performed on the normalized IMU velocity information and the normalized GPS velocity information, to respectively obtain a unit vector corresponding to the normalized IMU velocity information in a horizontal plane and a unit vector corresponding to the normalized GPS velocity information in a horizontal plane, and a vector angle between the two unit vectors is calculated, to obtain the velocity difference.

Step S55: Differentiate the velocity difference to generate the second yaw angular velocity error value.

Specifically, because the accelerometer of the IMU has a bias, the accuracy of the calculated velocity difference is not high, but after differential processing, the impact of the bias can be eliminated. Therefore, the velocity difference is differentiated for correction, to generate the second yaw angular velocity error value. It can be understood that, after the differentiating the velocity difference, the method further includes: filtering the differentiated velocity difference. There are a variety of filtering algorithms, such as Kalman filtering, mean filtering, frequency domain low-pass filtering, and so on. By differentiating and filtering the velocity difference, the second yaw angular velocity error value is generated.

Step S60: Determine a final complementary fusion yaw according to the initial complementary fusion yaw angular velocity and the second yaw angular velocity error value.

The initial complementary fusion yaw angular velocity and the second yaw angular velocity error value are both yaw angular velocity information of the aircraft and are not accurate enough. Therefore, in order to further improve the accuracy of fusion, secondary complementary filtering is performed on the initial complementary fusion yaw angular velocity and the second yaw angular velocity error value to generate accurate yaw angular velocity information.

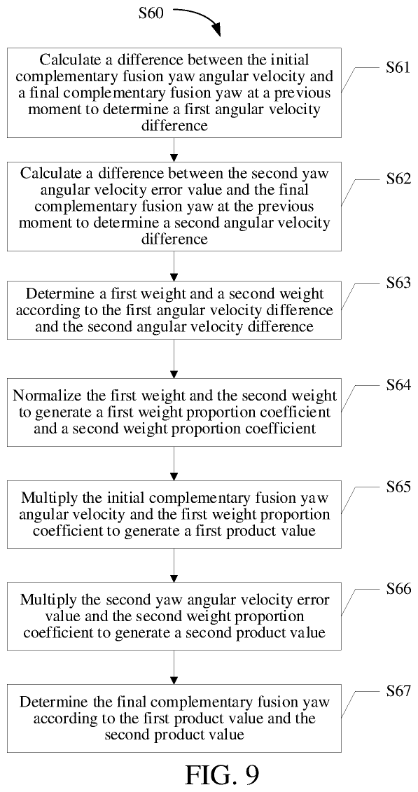

Specifically, FIG. 9 is a detailed flowchart of step S60 in FIG. 5.

As shown in FIG. 9, the determining a final complementary fusion yaw according to the initial complementary fusion yaw angular velocity and the second yaw angular velocity error value includes the following steps:

Step S61: Calculate a difference between the initial complementary fusion yaw angular velocity and a final complementary fusion yaw at a previous moment to determine a first angular velocity difference.

Specifically, the final complementary fusion yaw at the previous moment is a final complementary fusion yaw obtained by the previous fusion, and because error calculation is continuously carried out through the feedback loop for each sampling step of the aircraft, i.e., the yaw is constantly updated, each sampling moment corresponds to a unique final complementary fusion yaw. The step of calculating the difference between the initial complementary fusion yaw angular velocity and the final complementary fusion yaw at the previous moment and using the difference as the first angular velocity difference facilitates the error correction.

In an embodiment of the present invention, before the step of calculating a difference between the initial complementary fusion yaw angular velocity and a final complementary fusion yaw at a previous moment to determine a first angular velocity difference, the method further includes:

performing outlier elimination processing and filtering on the initial complementary fusion yaw angular velocity. It can be understood that in the initial complementary fusion yaw angular velocity signal, there are values that vary greatly from others, which are called outliers. Setting the outliers to zero is equivalent to performing outlier elimination processing. The filtering is performed using a filtering algorithm. There are a variety of filtering algorithms, such as Kalman filtering, mean filtering, frequency domain low-pass filtering, and so on.

Step S62: Calculate a difference between the second yaw angular velocity error value and the final complementary fusion yaw at the previous moment to determine a second angular velocity difference.

Specifically, the final complementary fusion yaw at the previous moment is a final complementary fusion yaw obtained by the previous fusion, and because error calculation is continuously carried out through the feedback loop for each sampling step of the aircraft, i.e., the yaw is constantly updated, each sampling moment corresponds to a unique final complementary fusion yaw. The step of calculating the difference between the second yaw angular velocity error value and the final complementary fusion yaw at the previous moment and using the difference as the second angular velocity difference facilitates the error correction.

In an embodiment of the present invention, before the step of calculating a difference between the second yaw angular velocity error value and the final complementary fusion yaw at the previous moment to determine a second angular velocity difference, the method further includes:

performing outlier elimination processing on the second yaw angular velocity error value. The second angular velocity difference is determined according to the difference between the result of the outlier elimination processing and the final complementary fusion yaw at the previous moment.

Step S63: Determine a first weight and a second weight according to the first angular velocity difference and the second angular velocity difference.

Specifically, the determining a first weight and a second weight according to the first angular velocity difference and the second angular velocity difference includes: summing the first angular velocity difference and the second angular velocity difference to obtain a summation result, respectively calculating a ratio of the first angular velocity difference to the summation result and a ratio of the second angular velocity difference to the summation result, using the ratio of the first angular velocity difference to the summation result as the first weight, and using the ratio of the second angular velocity difference to the summation result as the second weight.

Step S64: Normalize the first weight and the second weight to generate a first weight proportion coefficient and a second weight proportion coefficient.

Specifically, the first weight and the second weight are respectively normalized to generate a first weight proportion coefficient and a second weight proportion coefficient, where the first weight proportion coefficient and the second weight proportion coefficient are used for eliminating the impact caused by the differences in magnitude of fusion values of the initial complementary fusion yaw angular velocity and the second yaw angular velocity error value. By weighted averaging based on the weight proportion coefficients, a more accurate result can be obtained.

Step S65: Multiply the initial complementary fusion yaw angular velocity and the first weight proportion coefficient to generate a first product value.

Step S66: Multiply the second yaw angular velocity error value and the second weight proportion coefficient to generate a second product value.

Step S67: Determine the final complementary fusion yaw according to the first product value and the second product value.

Specifically, the first product value and the second product value are summed, and a result of the summation is used as the final complementary fusion yaw.

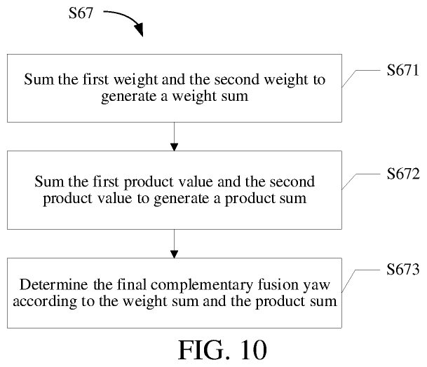

FIG. 10 is a detailed flowchart of step S67 in FIG. 9.

As shown in FIG. 10, the determining the final complementary fusion yaw according to the first product value and the second product value includes the following steps:

Step S671: Sum the first weight and the second weight to generate a weight sum.

Step S672: Sum the first product value and the second product value to generate a product sum.

Step S673: Determine the final complementary fusion yaw according to the weight sum and the product sum.

Specifically, the product sum is divided by the weight sum, and a result of the division is used as the final complementary fusion yaw. The accuracy of fusion can be further improved by dividing the product sum by the weight sum.

In this embodiment of the present invention, provided is a method for yaw fusion, applicable to an aircraft, the method including: acquiring magnetometer data, IMU data, and GPS data, where the IMU data includes IMU acceleration information and IMU angular velocity information, and the GPS data includes GPS velocity information and GPS acceleration information; determining a yaw angular velocity correction amount according to the GPS data and the magnetometer data; determining a first yaw angular velocity error value according to the IMU acceleration information and the GPS acceleration information; determining an initial complementary fusion yaw angular velocity according to the IMU angular velocity information, the yaw angular velocity correction amount, and the first yaw angular velocity error value; determining a second yaw angular velocity error value according to the IMU acceleration information and the GPS velocity information; and determining a final complementary fusion yaw according to the initial complementary fusion yaw angular velocity and the second yaw angular velocity error value. Whereby, this embodiment of the present invention solves the technical problem of a large error in primary complementary filtering and improve the fusion precision and stability of the yaw.

### Embodiment 2

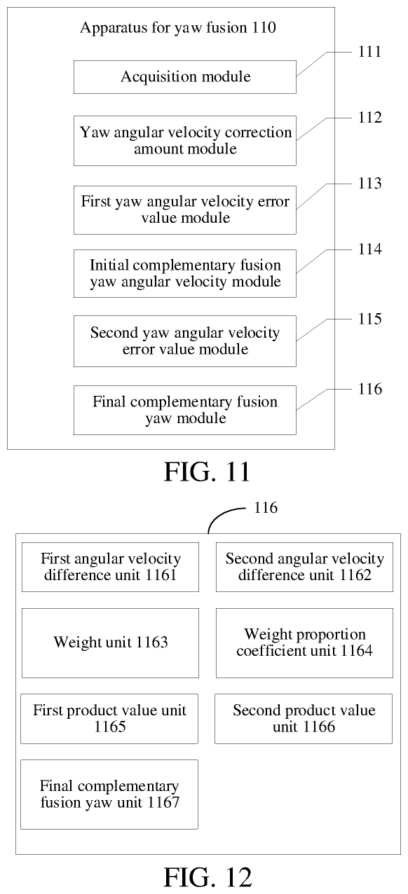

FIG. 11 is a schematic diagram of an apparatus for yaw fusion according to an embodiment of the present invention.

As shown in FIG. 11, the apparatus for yaw fusion 110 is applied to an aircraft. Specifically, the apparatus for yaw fusion 110 may be a flight controller of an aircraft, and includes:

an acquisition module 111, configured to acquire magnetometer data, IMU data, and GPS data, where the IMU data includes IMU acceleration information and IMU angular velocity information, and the GPS data includes GPS velocity information and GPS acceleration information;

a yaw angular velocity correction amount module 112, configured to determine a yaw angular velocity correction amount according to the GPS data and the magnetometer data;

a first yaw angular velocity error value module 113, configured to determine a first yaw angular velocity error value according to the IMU acceleration information and the GPS acceleration information;

an initial complementary fusion yaw angular velocity module 114, configured to determine an initial complementary fusion yaw angular velocity according to the IMU angular velocity information, the yaw angular velocity correction amount, and the first yaw angular velocity error value;

a second yaw angular velocity error value module 115, configured to determine a second yaw angular velocity error value according to the IMU acceleration information and the GPS velocity information; and

a final complementary fusion yaw module 116, configured to determine a final complementary fusion yaw according to the initial complementary fusion yaw angular velocity and the second yaw angular velocity error value.

In an embodiment of the present invention, the yaw angular velocity correction amount module 112 is further configured to:

acquire a magnetic field vector of a current location of the aircraft according to the GPS data;

determine a magnetic field vector of the magnetometer according to the magnetometer data;

calculate a magnetic north pole error angle according to the magnetic field vector of the current location of the aircraft and the magnetic field vector of the magnetometer; and

determine the yaw angular velocity correction amount according to the magnetic north pole error angle.

In an embodiment of the present invention, the first yaw angular velocity error value module 113 is further configured to:

perform coordinate transformation on the IMU data to generate IMU acceleration information in an earth coordinate system;

perform signal processing on the GPS data to generate horizontal acceleration information; and

calculate a vector angle according to the IMU acceleration information in the earth coordinate system and the horizontal acceleration information, and use the vector angle as the first yaw angular velocity error value.

In an embodiment of the present invention, the initial complementary fusion yaw angular velocity module 114 is further configured to:

sum the IMU angular velocity information in the earth coordinate system, the yaw angular velocity correction amount, and the first yaw angular velocity error value, and use a result of the summation as the initial complementary fusion yaw angular velocity.

In an embodiment of the present invention, the second yaw angular velocity error value module 115 is further configured to:

integrate the IMU acceleration information to generate integral IMU velocity information;

normalize the integral IMU velocity information to generate normalized IMU velocity information;

normalize the GPS velocity information to generate normalized GPS velocity information;

generate a velocity difference according to the normalized IMU velocity information and the normalized GPS velocity information; and

differentiate the velocity difference to generate the second yaw angular velocity error value.

In an embodiment of the present invention, the apparatus further includes:

a stationary flag module, configured to generate a stationary flag according to the IMU data, where the stationary flag is used for reflecting whether the aircraft is in a stationary state;

an IMU bias data difference module, configured to obtain bias data of the IMU data according to the IMU data and the stationary flag; and obtain a difference between the IMU data and the bias data of the IMU data; and

the first yaw angular velocity error value module is further configured to:

perform coordinate transformation on the difference between the IMU data and the bias data of the IMU data to generate the IMU acceleration information in the earth coordinate system.

FIG. 12 is a schematic diagram of a final complementary fusion yaw module in FIG. 11.

As shown in FIG. 12, the final complementary fusion yaw module 116 includes:

a first angular velocity difference unit 1161, configured to calculate a difference between the initial complementary fusion yaw angular velocity and a final complementary fusion yaw at a previous moment to determine a first angular velocity difference;

a second angular velocity difference unit 1162, configured to calculate a difference between the second yaw angular velocity error value and the final complementary fusion yaw at the previous moment to determine a second angular velocity difference;

a weight unit 1163, configured to determine a first weight and a second weight according to the first angular velocity difference and the second angular velocity difference;

a weight proportion coefficient unit 1164, configured to normalize the first weight and the second weight to generate a first weight proportion coefficient and a second weight proportion coefficient;

a first product value unit 1165, configured to multiply the initial complementary fusion yaw angular velocity and the first weight proportion coefficient to generate a first product value;

a second product value unit 1166, configured to multiply the second yaw angular velocity error value and the second weight proportion coefficient to generate a second product value; and

a final complementary fusion yaw unit 1167, configured to determine the final complementary fusion yaw according to the first product value and the second product value.

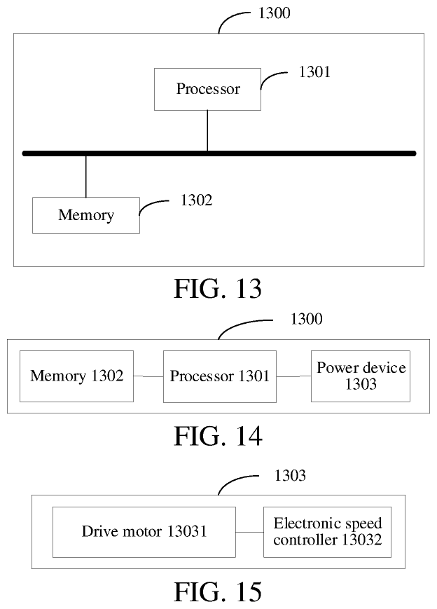

FIG. 13 is a schematic diagram of a hardware structure of an aircraft according to an embodiment of the present invention. The aircraft may be a UAV, an unmanned spacecraft, or other electronic devices.

As shown in FIG. 13, the aircraft 1300 includes one or more processors 1301 and a memory 1302. FIG. 13 uses one processor 1301 as an example.

The processor 1301 and the memory 1302 may be connected by a bus or in other ways. Connection by a bus is used as an example in FIG. 13.

The memory 1302, as a non-volatile computer-readable storage medium, may be configured to store a non-volatile software program, a non-volatile computer-executable program, and modules, for example, units corresponding to the method for yaw fusion in the embodiments of the present invention (for example, the modules or units described in FIG. 11 to FIG. 12). By running the non-volatile software programs, instructions, and modules stored in the memory 1302, the processor 1301 executes various functional applications and data processing in method for yaw fusion, i.e., implements the method for yaw fusion in the above method embodiments and functions of the modules and units of the above apparatus embodiments.

The memory 1302 may include a high speed random access memory, and may also include a nonvolatile memory, e.g., at least one magnetic disk storage device, flash memory device, or other nonvolatile solid-state storage device. In some embodiments, the memory 1302 may optionally include memories located remotely from the processor 1301, and the remote memories may be connected to the processor 1301 via a network. Examples of the network include, but are not limited to, the Internet, an intranet, a local area network, a mobile communication network, and combinations thereof.

The modules are stored in the memory 1302, and when executed by the one or more processors 1301, execute the method for yaw fusion in any of the above method embodiments, e.g., executes the steps shown in FIG. 5 to FIG. 10 above; and may also implement the functions of the modules or units described in FIG. 11 to FIG. 12.

Referring to FIG. 14 and FIG. 15, the aircraft 1300 further includes a power device 1303. The power device 1303 is configured to provide power for flight of the aircraft. The power device 1303 is connected to the processor 1301. The power device 1303 includes: a drive motor 13031 and an electronic speed controller 13032. The electronic speed controller 13032 is electrically connected to the drive motor 13031 and is configured to control the drive motor 13031. Specifically, the electronic speed controller 13032 generates a control instruction based on a fused yaw obtained after the processor 1301 executes the above method for yaw fusion, and controls the drive motor 13031 according to the control instruction.

The aircraft 1300 can execute the method for yaw fusion provided in Embodiment 1 of the present invention, and has functional modules and beneficial effects corresponding to the method executed. For technical details that are not described in detail in the embodiments of the aircraft, reference can be made to the method for yaw fusion provided in Embodiment 1 of the present invention.

An embodiment of the present invention provides a computer program product. The computer program product includes a computer program stored on a non-volatile computer-readable storage medium. The computer program includes program instructions. The program instructions, when executed by a computer, cause the computer to execute the above method for yaw fusion. For example, the foregoing step S10 to step S60 of the method in FIG. 5 are executed.

An embodiment of the present invention also provides a non-volatile computer storage medium. The computer storage medium stores computer-executable instructions. The computer-executable instructions, when executed by one or more processors, e.g., a processor 1301 in FIG. 13, can cause the one or more processors to execute the method for yaw fusion in any of the above method embodiments, e.g., executes the steps shown in FIG. 5 to FIG. 10 above; and can also cause the one or more processors to implement the functions of the modules or units described in FIG. 11 to FIG. 12.

In this embodiment of the present invention, provided is an apparatus for yaw fusion, applicable to an aircraft, the apparatus including: an acquisition module, configured to acquire magnetometer data, IMU data, and GPS data, where the IMU data includes IMU acceleration information and IMU angular velocity information, and the GPS data includes GPS velocity information and GPS acceleration information; a yaw angular velocity correction amount module, configured to determine a yaw angular velocity correction amount according to the GPS data and the magnetometer data; a first yaw angular velocity error value module, configured to determine a first yaw angular velocity error value according to the IMU acceleration information and the GPS acceleration information; an initial complementary fusion yaw angular velocity module, configured to determine an initial complementary fusion yaw angular velocity according to the IMU angular velocity information, the yaw angular velocity correction amount, and the first yaw angular velocity error value; a second yaw angular velocity error value module, configured to determine a second yaw angular velocity error value according to the IMU acceleration information and the GPS velocity information; and a final complementary fusion yaw module, configured to determine a final complementary fusion yaw according to the initial complementary fusion yaw angular velocity and the second yaw angular velocity error value. Whereby, this embodiment of the present invention solves the technical problem of a large error in primary complementary filtering and improve the fusion precision and stability of the yaw.

The described apparatus or device embodiments are merely exemplary. The unit modules described as separate components may or may not be physically separated, and the components displayed as module units may or may not be physical units, and may be located in one place or may be distributed over a plurality of network module units. Some or all of the modules may be selected according to actual needs to achieve the objectives of the solutions of the embodiments.

Based on the descriptions of the foregoing implementations, a person skilled in the art may clearly understand that the implementations may be implemented by software in addition to a universal hardware platform, or by hardware. Based on such an understanding, the foregoing technical solutions essentially or the part contributing to the related technology may be implemented in a form of a software product. The computer software product may be stored in a computer-readable storage medium, such as a read-only medium (ROM)/a random access memory (RAM), a magnetic disk, or an optical disc, and includes several instructions for instructing a computer device (which may be a personal computer, a server, a network device, or the like) to perform the methods described in the embodiments or some parts of the embodiments.

Finally, it should be noted that: the foregoing embodiments are merely used for describing the technical solutions of the present invention, but are not intended to limit the present invention. Under the ideas of the present invention, the technical features in the foregoing embodiments or different embodiments may also be combined, the steps may be performed in any order, and many other changes of different aspects of the present invention also exists as described above, and these changes are not provided in detail for simplicity. Although the present invention is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of the present application.

What is claimed is:

1. A method for yaw fusion, applicable to an aircraft, the method comprising:
acquiring magnetometer data, inertial measurement unit (IMU) data, and global positioning system (GPS) data, wherein the IMU data comprises IMU acceleration information and IMU angular velocity information, and the GPS data comprises GPS velocity information and GPS acceleration information;
determining a yaw angular velocity correction amount according to the GPS data and the magnetometer data;
determining a first yaw angular velocity error value according to the IMU acceleration information and the GPS acceleration information;
determining an initial complementary fusion yaw angular velocity according to the IMU angular velocity information, the yaw angular velocity correction amount, and the first yaw angular velocity error value;
determining a second yaw angular velocity error value according to the IMU acceleration information and the GPS velocity information; and
determining a final complementary fusion yaw according to the initial complementary fusion yaw angular velocity and the second yaw angular velocity error value.

2. The method according to claim 1, wherein the determining a yaw angular velocity correction amount according to the GPS data and the magnetometer data comprises:
acquiring a magnetic field vector of a current location of the aircraft according to the GPS data;
determining a magnetic field vector of the magnetometer according to the magnetometer data;
calculating a magnetic north pole error angle according to the magnetic field vector of the current location of the aircraft and the magnetic field vector of the magnetometer; and
determining the yaw angular velocity correction amount according to the magnetic north pole error angle.

3. The method according to claim 1, wherein the determining a first yaw angular velocity error value according to the IMU acceleration information and the GPS acceleration information comprises:
performing coordinate transformation on the IMU data to generate IMU acceleration information in an earth coordinate system;
performing signal processing on the GPS data to generate horizontal acceleration information; and
calculating a vector angle according to the IMU acceleration information in the earth coordinate system and the horizontal acceleration information, and using the vector angle as the first yaw angular velocity error value.

4. The method according to claim 3, wherein before the performing coordinate transformation on the IMU data to generate IMU acceleration information in an earth coordinate system, the method further comprises:
generating a stationary flag according to the IMU data, wherein the stationary flag is used for reflecting whether the aircraft is in a stationary state;
obtaining bias data of the IMU data according to the IMU data and the stationary flag; and
obtaining a difference between the IMU data and the bias data of the IMU data; and
the performing coordinate transformation on the IMU data to generate IMU acceleration information in an earth coordinate system comprises:
performing coordinate transformation on the difference between the IMU data and the bias data of the IMU data to generate the IMU acceleration information in the earth coordinate system.

5. The method according to claim 3, wherein the determining an initial complementary fusion yaw angular velocity according to the IMU angular velocity information, the yaw angular velocity correction amount, and the first yaw angular velocity error value comprises:
summing the IMU angular velocity information in the earth coordinate system, the yaw angular velocity correction amount, and the first yaw angular velocity error value, and using a result of the summation as the initial complementary fusion yaw angular velocity.

6. The method according to claim 1, wherein the determining a second yaw angular velocity error value according to the IMU acceleration information and the GPS velocity information comprises:
integrating the IMU acceleration information to generate integral IMU velocity information;
normalizing the integral IMU velocity information to generate normalized IMU velocity information;
normalizing the GPS velocity information to generate normalized GPS velocity information;
generating a velocity difference according to the normalized IMU velocity information and the normalized GPS velocity information; and
differentiating the velocity difference to generate the second yaw angular velocity error value.

7. The method according to claim 1, wherein the determining a final complementary fusion yaw according to the initial complementary fusion yaw angular velocity and the second yaw angular velocity error value comprises:
calculating a difference between the initial complementary fusion yaw angular velocity and a final complementary fusion yaw at a previous moment to determine a first angular velocity difference;
calculating a difference between the second yaw angular velocity error value and the final complementary fusion yaw at the previous moment to determine a second angular velocity difference;
determining a first weight and a second weight according to the first angular velocity difference and the second angular velocity difference;
normalizing the first weight and the second weight to generate a first weight proportion coefficient and a second weight proportion coefficient;
multiplying the initial complementary fusion yaw angular velocity and the first weight proportion coefficient to generate a first product value;
multiplying the second yaw angular velocity error value and the second weight proportion coefficient to generate a second product value; and
determining the final complementary fusion yaw according to the first product value and the second product value.

8. The method according to claim 7, wherein the determining the final complementary fusion yaw according to the first product value and the second product value comprises:
summing the first weight and the second weight to generate a weight sum;
summing the first product value and the second product value to generate a product sum; and
determining the final complementary fusion yaw according to the weight sum and the product sum.

9. An apparatus for yaw fusion, applicable to an aircraft, the apparatus comprising: at least one processor; and
a memory communicably connected to the at least one processor, wherein
the memory stores instructions executable by the at least one processor, wherein the instructions are executed by the at least one processor to cause the at least one processor to execute:
acquiring magnetometer data, inertial measurement unit (IMU) data, and global positioning system (GPS) data, wherein the IMU data comprises IMU acceleration information and IMU angular velocity information, and the GPS data comprises GPS velocity information and GPS acceleration information;
determining a yaw angular velocity correction amount according to the GPS data and the magnetometer data;
determining a first yaw angular velocity error value according to the IMU acceleration information and the GPS acceleration information;
determining an initial complementary fusion yaw angular velocity according to the IMU angular velocity information, the yaw angular velocity correction amount, and the first yaw angular velocity error value;
determining a second yaw angular velocity error value according to the IMU acceleration information and the GPS velocity information; and
determining a final complementary fusion yaw according to the initial complementary fusion yaw angular velocity and the second yaw angular velocity error value.

10. The apparatus according to claim 9, wherein the processor is further configured to:
acquire a magnetic field vector of a current location of the aircraft according to the GPS data;
determine a magnetic field vector of the magnetometer according to the magnetometer data;
calculate a magnetic north pole error angle according to the magnetic field vector of the current location of the aircraft and the magnetic field vector of the magnetometer; and
determine the yaw angular velocity correction amount according to the magnetic north pole error angle.

11. The apparatus according to claim 9, wherein the processor is further configured to:
perform coordinate transformation on the IMU data to generate IMU acceleration information in an earth coordinate system;
perform signal processing on the GPS data to generate horizontal acceleration information; and
calculate a vector angle according to the IMU acceleration information in the earth coordinate system and the horizontal acceleration information, and use the vector angle as the first yaw angular velocity error value.

12. The apparatus according to claim 11, wherein the processor is further configured to:
generate a stationary flag according to the IMU data, wherein the stationary flag is used for reflecting whether the aircraft is in a stationary state;
obtain bias data of the IMU data according to the IMU data and the stationary flag; and
obtain a difference between the IMU data and the bias data of the IMU data;
perform coordinate transformation on the difference between the IMU data and the bias data of the IMU data to generate the IMU acceleration information in the earth coordinate system.

13. The apparatus according to claim 11, wherein the processor is further configured to:
sum the IMU angular velocity information in the earth coordinate system, the yaw angular velocity correction amount, and the first yaw angular velocity error value, and use a result of the summation as the initial complementary fusion yaw angular velocity.

14. The apparatus according to claim 9, wherein the processor is further configured to:
integrate the IMU acceleration information to generate integral IMU velocity information;
normalize the integral IMU velocity information to generate normalized IMU velocity information;
normalize the GPS velocity information to generate normalized GPS velocity information;
generate a velocity difference according to the normalized IMU velocity information and the normalized GPS velocity information; and
differentiate the velocity difference to generate the second yaw angular velocity error value.

15. The apparatus according to claim 9, wherein the processor is further configured to:
calculate a difference between the initial complementary fusion yaw angular velocity and a final complementary fusion yaw at a previous moment to determine a first angular velocity difference;
calculate a difference between the second yaw angular velocity error value and the final complementary fusion yaw at the previous moment to determine a second angular velocity difference;
determine a first weight and a second weight according to the first angular velocity difference and the second angular velocity difference;
normalize the first weight and the second weight to generate a first weight proportion coefficient and a second weight proportion coefficient;
multiply the initial complementary fusion yaw angular velocity and the first weight proportion coefficient to generate a first product value;
multiply the second yaw angular velocity error value and the second weight proportion coefficient to generate a second product value; and
determine the final complementary fusion yaw according to the first product value and the second product value.

16. The apparatus according to claim 15, wherein the processor is further configured to:
sum the first weight and the second weight to generate a weight sum;
sum the first product value and the second product value to generate a product sum; and
determine the final complementary fusion yaw according to the weight sum and the product sum.

17. An aircraft, comprising:
a body;
an arm, connected to the body;
a power device, disposed on the arm and configured to supply power for flight of the aircraft; and
a flight controller, disposed on the body,
wherein the flight controller comprises:
at least one processor; and
a memory communicably connected to the at least one processor, wherein
the memory stores instructions executable by the at least one processor, wherein the instructions are executed by the at least one processor to cause the at least one processor to execute:
acquiring magnetometer data, inertial measurement unit (IMU) data, and global positioning system (GPS) data, wherein the IMU data comprises IMU acceleration information and IMU angular velocity information, and the GPS data comprises GPS velocity information and GPS acceleration information;
determining a yaw angular velocity correction amount according to the GPS data and the magnetometer data;
determining a first yaw angular velocity error value according to the IMU acceleration information and the GPS acceleration information;
determining an initial complementary fusion yaw angular velocity according to the IMU angular velocity information, the yaw angular velocity correction amount, and the first yaw angular velocity error value;
determining a second yaw angular velocity error value according to the IMU acceleration information and the GPS velocity information; and
determining a final complementary fusion yaw according to the initial complementary fusion yaw angular velocity and the second yaw angular velocity error value.
